(19) United States
(12) Patent Application Publication
(10) Pub. No.: US 2013/0292863 A1
(43) Pub. Date: Nov. 7, 2013

(54) METHODS AND SYSTEMS FOR ADJUSTING THE COMPOSITION OF A BINDER SYSTEM FOR USE IN MAKING FIBERGLASS PRODUCTS

(71) Applicant: GEORGIA-PACIFIC CHEMICALS LLC, Atlanta, GA (US)

(72) Inventors: Kelly A. Shoemake, Atlanta, GA (US); Robert A. Breyer, Atlanta, GA (US)

(73) Assignee: Georgia-Pacific Chemicals LLC, Atlanta, GA (US)

(21) Appl. No.: 13/874,711

(22) Filed: May 1, 2013

Related U.S. Application Data
(60) Provisional application No. 61/642,259, filed on May 3, 2012.

(51) Int. Cl. B29C 31/02

(52) U.S. Cl. CPC B29C 31/02
USPC 264/40.1; 366/76.2

(57) ABSTRACT

Methods and systems for preparing a binder system for use in producing fiberglass products are provided. The method can include combining at least a first resin and a component to produce a first binder system. The component can include a second resin, an additive, or a combination thereof. At least a portion of the first binder system can be applied to a first plurality of fibers. One or more process variables can be monitored. The one or more process variables can be evaluated. An amount of the first resin, the component, or both combined with one another can be adjusted in response to the evaluation of the one or more monitored process variables to produce a second binder system.

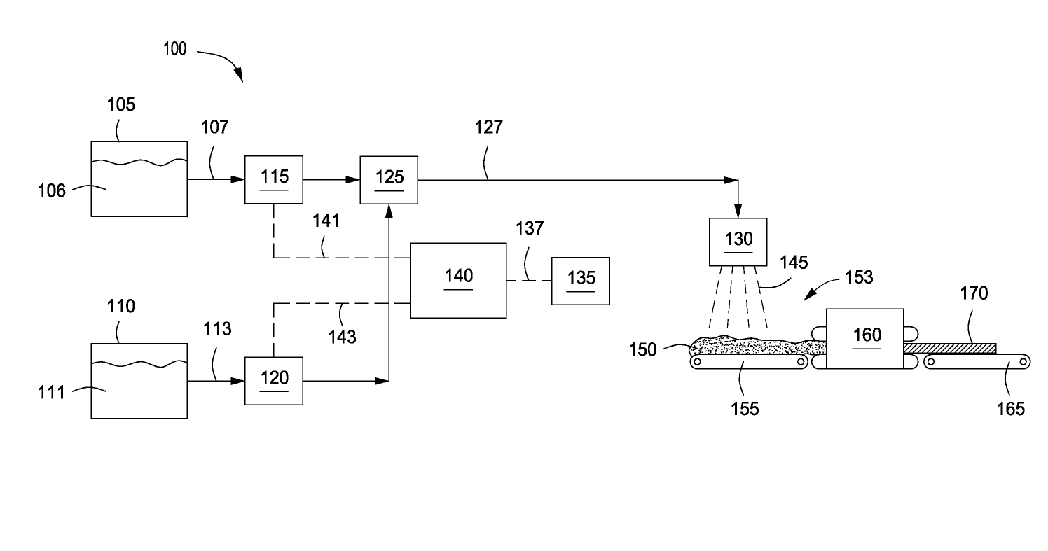

### CROSS-REFERENCE TO RELATED APPLICATION

This application claims priority to U.S. Provisional Patent Application having Ser. No. 61/642,259, filed on May 3, 2012, which is incorporated by reference herein.

### BACKGROUND

1. Field

Embodiments described herein generally relate to methods and systems for adjusting the composition of a binder system for use in making fiberglass products. More particularly, such embodiments relate to methods and systems for adjusting the amount of at least one component in the binder system based, at least in part, on one or more monitored process variables.

2. Description of the Related Art

Sheets or mats of non-woven fibers, e.g., glass fibers, are used in a wide range of applications. For example, fiberglass mats are typically used in insulation materials, flooring products, wall panel products, and roofing products. Fiberglass mats are usually made commercially by a wet-laid process that involves the addition of a binder or adhesive to the glass fiber mat to bind and hold the fibers together. Typical adhesives or binders used in the production of fiberglass products include resins, such as phenol-formaldehyde (PF), and resins extended with urea, such as phenol-formaldehyde-urea (PFU) resins.

Depending on the particular fiberglass product and its particular application, different mechanical properties are desirable and/or must be met, such as tear strength, dry tensile strength, and/or wet tensile strength. The particular binder system and process conditions used to produce a given fiberglass product can have an effect on the properties of the final product. For example, a particular binder system may produce a fiberglass product, e.g., a fiber mat, having exceptional tear strength under a first set of process conditions, but the same binder system, when used to produce the same fiberglass product, but under a second set of process conditions that differ from the first set, may produce fiberglass products having unacceptable tear strength or reduced tear strength as compared to the fiberglass product made under the first set of process conditions.

There is a need, therefore, for new methods and systems for adjusting the composition of a binder system for use in making fiberglass products.

### SUMMARY

Methods and systems for adjusting the composition of a binder system used for making fiberglass products are provided. In one or more embodiments, the method can include combining at least a first resin and a component to produce a first binder system. The component can include a second resin, an additive, or a combination thereof. At least a portion of the first binder system can be applied to a first plurality of fibers. One or more process variables can be monitored. The one or more process variables can be evaluated. An amount of the first resin, the component, or both combined with one another can be adjusted in response to the evaluation of the one or more monitored process variables to produce a second binder system.

In one or more embodiments, the method for preparing a binder system for use in producing fiber products can include combining a first resin and a component to produce a first binder system. The component can include a second resin, an additive, or a combination thereof. The first binder system can have a first weight ratio of the first resin to the component, based on a solids weight of the first resin and the component. A first plurality of fibers can e contacted with the first binder system to product a first mixture. The first binder system in the first mixture can be at least partially cured to produce a first fiber product. One or more process variables can be monitored. The one or more monitored process variables can be evaluated. An amount of the first resin, the component, or both combined with one another can be adjusted to produce a second binder system having a second weight ratio of the first resin to the component, based on a solids weight of the first resin and the component. The adjustment in the amount of the first resin, the component, or both can be based, at least in part, on the evaluation of the one or more monitored process variables. A second plurality of fibers can be contacted with the second binder system to produce a second mixture. The second binder system in the second mixture can be at least partially cured to produce a second fiber product.

In one or more embodiments, the system for producing a binder system and one or more fiber products can include a first vessel in fluid communication with a first flow control device. The first vessel can be adapted to contain a first resin. The system can also include a second vessel in fluid communication with a second flow control device. The second vessel can be adapted to contain a component. the component can include a second resin, an additive, or a combination thereof. The system can also include at least one process variable monitor adapted to monitor one or more process variables. The system can also include a control system for evaluating the one or more monitored process variables and controlling the first flow control device, the second control device, or both based on the evaluated one or more monitored process variables. The system can also include a mixer adapted to combine the first resin and the component to produce a first binder system. The system can also include a binder application unit configured to contact at least a portion of the binder system with a plurality of fibers to produce a binder system and fiber mixture.

### BRIEF DESCRIPTION OF THE DRAWINGS

The FIGURE depicts an illustrative system for varying the composition of a binder system, according to one or more embodiments described.

### DETAILED DESCRIPTION

The adhesive or binder system can include two or more components. For example, the binder system can include a first component, e.g., a first resin, and a second component, e.g., a second resin, where the first and second components differ from one another. The first component and the second component can be mixed, blended, contacted, or otherwise combined with one another to produce the binder system. In another example, the binder system can include a first component, a second component, a third component, and optionally any number of other components, e.g., a fourth component, a fifth component, a sixth component, or more, where the components differ from one another. The binder system can be applied to a plurality of fibers and at least partially cured to produce a fiberglass product.

For simplicity and ease of description, the binder system will be further discussed and described in the context of a two resin binder system, i.e., as a binder system having a first component that can be or include a first resin and a second component that can be or include a second resin, combined with one another. However, the binder system can also be or include one or more additives in lieu of or in addition to the first resin and/or the second resin. As such, in the context of the two resin binder systems discussed and described herein, the first resin and/or the second resin can be substituted and/or combined with an additive or a combination of additives.

The first resin can be present in the binder system in an amount ranging from about 0.01 wt % to about 99.9 wt %, based on the combined solids weight of the first resin and the second resin. For example, the first resin can be present in an amount ranging from a low of about 0.1 wt %, about 0.5 wt %, about 1 wt %, about 5 wt %, about 10 wt %, about 15 wt %, about 25 wt %, or about 35 wt % to a high of about 65 wt %, about 75 wt %, about 85 wt %, or about 95 wt %, based on the combined solids weight of the first and second resins. In another example, the first resin can be present in an amount ranging from a low of about 0.01 wt %, about 0.1 wt %, about 0.05 wt %, about 0.5 wt %, about 1 wt %, about 1.5 wt %, or about 2 wt % to a high of about 3 wt %, about 5 wt %, about 7 wt %, about 9 wt %, or about 11 wt %, based on the combined solids weight of the first and second resins. In another example, the first resin can be present in an amount ranging from about 1 wt % to about 15 wt %, about 3 wt % to about 20 wt %, about 5 wt % to about 25 wt %, about 10 wt % to about 35 wt %, about 15 wt % to about 45 wt %, about 20 wt % to about 50 wt %, or about 25 wt % to about 50 wt %, based on the combined solids weight of the first and second resins. When three or more resins are combined to provide the binder system, the three or more resins can be present in any amount. For example, in the context of a binder system that includes a first, second, and third resin, the first resin can be present in an amount of from about 0.5 wt % to about 99 wt %, the second resin can be present in an amount of from about 0.5 wt % to about 99 wt %, and the third resin can be present in an amount of from about 0.5 wt % to about 99 wt %, based on the combined solids weight of the first, second, and third resins.

The solids content or solids weight of the first resin, the second resin, and/or the binder system, as understood by those skilled in the art, can be measured by determining the weight loss upon heating a small sample, e.g., 1-5 grams of the binder system, to a suitable temperature, e.g., 125° C., and a time sufficient to remove the liquid. By measuring the weight of the sample before and after heating, the percent solids in the sample can be determined or estimated.

The first and second resins can have at least one property or characteristic different from one another. The first resin can include one or more compounds or components that are not present in the second resin. For example, the first resin can include formaldehyde and the second resin can be free from formaldehyde or free from any intentionally added formaldehyde. The first and second resins can both include the same compound(s), but the relative amount(s) of the compound(s) in each resin can differ with respect to one another. For example, the first and second resins can both be phenol-formaldehyde resins, but a molar ratio between the phenol and formaldehyde in the first and second resins can differ. The first and second resins can both include the same compound(s) in the same ratio(s) with respect to one another, but the particular compound formed in the first resin can be different from the particular compound formed in the second resin. For example, both the first and second resins can be a styrene acrylate polymer combined with one another at the same ratio, but the first resin can include a styrene acrylate copolymer having a bimodal molecular weight distribution while the second resin can include a styrene acrylate copolymer having a monomodal molecular weight distribution. Other differences between the first and second resin can include, but are not limited to, the degree or level of resin advancement or condensation, molecular weight, e.g., high molecular weight versus low molecular weight, resin alkalinity, and the like.

The particular composition of the binder system can be based, at least in part, on one or more monitored process variables. The composition of the binder system can be changed, altered, or otherwise adjusted as one or more of the monitored process variables change. The composition of the binder system can be adjusted before and/or during production of the fiberglass products. The composition of the binder system can be adjusted on a continuous basis, a periodic time cycle, a variable time cycle, or a combination thereof. For example, the composition of the binder system can be adjusted on a continuous basis during production of the fiberglass products, periodically, e.g., every ten minutes, hourly, or daily, when a process variable changes, when two or more process variables change, and the like. Adjusting the binder composition in response to one or more monitored process variables can, at least partially, account for any effect a change in the process variable(s) may have on one or more properties of the fiberglass product. In other words, preparation or production of the binder system can include, but is not limited to, monitoring one or more process variables and adjusting or controlling the composition of the binder system based, at least in part, on at least one of the one or more monitored process variables.

Adjusting or controlling the composition of the binder system based, at least in part, on the one or more monitored process variables can provide fiberglass product(s) and/or the process(es) for making or producing the fiberglass product(s) that has one or more improved or enhanced properties as compared to using a binder containing only a single resin and/or a pre-mixed or pre-combined binder containing two or more different resins at a fixed or non-adjustable weight ratio. In other words, one or more properties of the composite products) and/or the process for producing the composite product(s) can be improved by monitoring one or more process variables and controlling the composition of the binder system, based at least in part, on the monitored process variable(s).

For example, when the first resin contains formaldehyde and the second resin is free of formaldehyde, adjusting the weight ratio of the first resin to the second resin in the binder, based at least in part on the monitored process variables, can be used to provide a production process and/or a fiberglass product having one or more desired, acceptable, and/or required properties while also reducing or minimizing a level of formaldehyde emitted from the process of producing the fiberglass product and/or the fiberglass product itself. In another example, controlling the composition of the binder system can be used to optimize one or more process variables such time required to at least partially cure the binder system to produce the fiberglass product, one or more product properties such as tear strength, or the like, that can be affected by one or more other varying or changing process variables such as one or more environmental or weather conditions, one or more substrate properties such as fiber composition, and/or one or more fiberglass product properties such as tensile strength.

For example, a first fiberglass product produced under a first set of process variables with a binder system having a first composition will have a first set of properties. If one or more of the process variables is altered such that a second set of process variables is present, the second fiberglass product produced under the second set of process variables with the same binder system as the first fiberglass product can have a second set of properties, where the first and second set of properties differ from one another. Adjusting the composition of the binder system to produce a binder system having a second composition can produce a fiberglass product having the first set of properties, when produced under the second set of process variables. In another example, adjusting the composition of the binder system to produce the binder system having the second composition can produce a fiberglass product having an intermediate set of properties, where the intermediate set of properties conforms more closely to the first set of properties in at least one aspect as compared to the second set of properties. As such, adjusting the composition of the binder system to provide a second binder system composition can facilitate production of a fiberglass product under the second set of process variables having one or more properties the same as or closer to the first set of properties as compared to the second set of properties the fiberglass product would have had absent adjustment of the binder system composition.

In another example, adjusting the composition of the binder system can be used to tailor, modify, alter, or otherwise adjust one or more properties of the fiberglass product. For example, tensile strength of a fiberglass product can be increased or decreased by adjusting a given composition of the binder system used to produce the fiberglass product. If the one or more process variables remain constant, i.e., no change, the composition of the binder system could be adjusted to produce a fiberglass product having one or more different properties. For example, a particular composition of the binder system can be optimized or otherwise improved to increase the tensile strength of a fiberglass product under a constant set of monitored process variables.

The one or more process variables can be monitored continuously, intermittently, randomly, periodically, upon the occurrence of one or more predetermined events, or any combination thereof. For example, the flow rates of the first resin and the second resin can be monitored periodically, e.g., every 5 seconds, 30 seconds, minute, 5 minutes, 10 minutes, 30 minutes, hour, two hours, 4 hours, 8 hours, 12 hours, 18 hours, or 24 hours, during production of the fiberglass product and/or production of the binder system. In another example, a particular process variable or multiple process variables can be monitored upon the occurrence of a predetermined event. Illustrative predetermined events can include, but are not limited to, a transition between the production of a first fiberglass product and the production of a second fiberglass product, a transition or change in a the temperature above or below a pre-set or predetermined value, a transition or change in atmospheric temperature to above or below a pre-set or predetermined value, a transition or change in a material of the fibers used in production of the fiberglass product, and the like.

Evaluation of the one or more monitored process variables can include any method or combination of methods capable of providing an indication as to an appropriate or desired composition of the binder system. For example, at least one of the one or more monitored process variables can be compared to a predetermined database containing previously monitored process variables. The predetermined database can undergo periodic, continuous, and/or random updates with additional process variables. For example, as the one or more process variables are monitored, at least a portion of the monitored process variables can be input or otherwise added to the predetermined database. In another example, a given number of any particular process variables can be averaged with one another and an average process variable can be input or otherwise added to the predetermined database.

The monitored process variable(s) can be compared to the previously determined monitored process variables in the predetermined database and the appropriate adjustment to the composition of the binder system in response to the monitored process variable(s) can be determined or estimated. For example, by comparing the monitored process variable(s) to the predetermined database of monitored process variables an estimate as to an adjustment in the composition of the binder system can be made, if needed, to produce a fiberglass product having one or more preferred properties when produced under the monitored process variables.

The pre-determined database can indicate a desired or preferred composition for the binder system being used to produce the fiberglass product based on previously estimated process variables acquired from one or more prior product production runs produced under the same and/or different process variables. The pre-determined database can include a listing of one or more values for one or more process variables and/or the predetermined database can be a generalized or averaged database listing ranges of values for one or more process variables.

The predetermined database can include any number of different process variables. For example, the predetermined database can include one, two, three, four, five, six, seven, eight, nine, ten, tens, hundreds, thousands or more different process variables that can be monitored. In another example, the number of different monitored process variables can range from a low of 1, 2, 3, 4, or 5 to a high of about 10, about 25, about 50, about 100, about 250, about 500, about 750, about 1,000, about 2,500, or about 5,000. In another example, the number of different monitored process variables can range from about 5 to about 100, about 1 to about 400, about 2 to about 20, about 3 to about 30, about 1 to 1,500, about 3 to about 10, about 4 to about 25, or about 7 to about 40. In another example, the number of monitored process variables can include at least two, at least 3, at least 4, at least 5, at least 6, at least 7, at least 8, at least 9, at least 10, at least 12, at least 14, at least 16, at least 18, at least 20, at least 22, at least 23, at least 24, or at least 26 different process variables.

The predetermined database can include any number of values for any give process variable that can be monitored. For example, the predetermined database can include one, two, three, four, five, six, seven, eight, nine, ten, tens, hundreds, thousands, tens of thousands, hundreds of thousands, millions or more values for any given process variable that can be monitored. As such, a particular monitored process variable or combination of monitored process variables can be compared or evaluated with respect to the pre-determined database and a determination as to a preferred or desired binder composition can be made, at least in part, based on that comparison or evaluation.

Evaluation of the one or more monitored process variables can also include manipulating at least one of the one or more monitored process variables to produce a manipulated process variable(s). The manipulated process variable(s) can be compared to the predetermined database that can include previously estimated values for the manipulated process variable(s). In another example, evaluating the one or more monitored process variables can include comparing the monitored process variable(s) as acquired, averaged with one or more other values for a given process variable, after manipulation, or a combination of monitored process variable(s) as acquired, averaged with one or more other values for a given process variable, and after manipulation thereof to the predetermined database.

The one or more monitored process variables can be compared or otherwise evaluated against the predetermined database of monitored process variables using any suitable method. For example, one or more software programs can be used to evaluate the monitored process variables. Evaluation of the one or more monitored process variables can include use or application of one or more mathematical algorithms to manipulate the monitored process conditions in order to generate an estimated change or adjustment that should be made to the amount of the first resin and/or the second resin combined to produce the binder having a preferred or desired composition based on the one or more monitored conditions. Illustrative mathematical algorithms can include, but are not limited to, linear regression modeling, non-linear regression modeling, multiple linear regression modeling, multiple non-linear regression modeling, neural network modeling, or any combination thereof.

Referring to multiple linear regression modeling in particular, multiple linear regression modeling can be used to evaluate a plurality of process variables to determine or estimate the preferred or desired composition for the binder system based, at least in part, on the plurality of monitored process variables. For example, for a two resin binder system containing formaldehyde, i.e., a binder composition produced by combining a first resin and a second resin, with at least one of the first and second resins containing formaldehyde, the process variables could include the level of formaldehyde emissions desired (Fₑₘᵢₛₛᵢₒₙ), a moisture content of the substrate (M_{substrate}), a substrate temperature (T_{substrate}), and finished product thickness (P_{thickness}). An illustrative multiple linear regression model that includes these process variables can be represented by Equation 1:

Fₑₘᵢₛₛᵢₒₙ=C+b₁(R)+b₂(M_{substrate})+b₃(T_{substrate})+b₄(P_{thickness}) (Equation 1)

where C, b₁, b₂, b₃, and b₄ are all constants derived from the linear regression model, R is equal to the ratio of the first resin to the second resin. In this example, one would know the desired level of formaldehyde emission (Fₑₘᵢₛₛᵢₒₙ), the moisture content of the substrate (M_{substrate}), the temperature of the substrate (T_{substrate}), and the thickness of the finished product (P_{thickness}) and could determine the correct weight ratio of the first resin to the second resin (R) in order to achieve the desired level (or reduction thereof) of formaldehyde emission.

Equation 1 can be modified to also include interactions of the different process variables by adding additional terms such as b₅(M_{substrate})(T_{substrate}). Equation 1 can also be modified to include higher order terms such as b₆(M_{substrate})(M_{substrate}), which could be used if the relationship between M_{substrate} and M_{substrate} is not linear, but curved.

Evaluating the monitored process variables or data can also include ranking, grouping, ordering, or otherwise organizing any two or more monitored process variables with respect to one another. For example, two or more monitored process variables can be ranked with respect to one another based on the effect the particular process variables have on one or more process properties or parameters, e.g., formaldehyde emission, press speed, cure speed, and/or one or more fiberglass product properties such as tensile strength and/or tear strength. For example, the temperature of the fibers when the binder system is contacted therewith can have a greater affect on a required cure time than the environmental humidity. As such, if the fiber temperature and environmental humidity were ranked, the fiber temperature would be ranked higher, i.e., carry more weight, as to the relevance or importance as compared to the environmental humidity. Accordingly, the particular fiber temperature and its increased importance on the overall process can be taken into account when evaluating both process variables, i.e., fiber temperature and environmental humidity.

In at least one example, the monitored process variables can be evaluated using computer software. Illustrative software programs can include, but are not limited to, Statistica, Stat Graphics, SAS, R, and Wind Bugs. Systems designed by the resin blending facility or plant, e.g., non-commercialized proprietary software can also be used. In another example, personnel can manually compare the monitored process variables to the predetermined database.

Referring to neural network modeling, the monitored process variables can be evaluated to see what particular process variables correlate to particular change(s) made to other process conditions during production of a composite product. For example, if the composition of the binder system is adjusted in response to a change in a process condition, e.g., substrate temperature, the neural network modeling can monitor the process variables and determine what particular process variables are affected the most versus those that are affected the least. As such, the neural network modeling can, at least in part, by its own logic determined the importance of monitored process variables and how monitored process variables affect one another. As such, the neural network modeling can rank monitored process variables according to importance. Linear effects and/or non-linear effects observed as the result of a particular process variable or combination of process variables can also be determined. For example, personnel can input desired vales for particular process variables, e.g., a particular internal bond strength, and the neural network can control or otherwise indicate a desired binder system composition for a give set of monitored process variables. As the monitored process variables change the neural network can adapt or learn from the changing process variables.

The monitored process variables can be or include any one or more of a number of conditions or parameters that can change during production of the binder system and/or the fiberglass product. The monitored process variables can include variables that occur prior to production of the binder system and the fiberglass product. For example, should the fibers be derived from organic matter, e.g., a plant, the geographical location of the plants from which the fibers were derived can be monitored. The monitored process variables can also include variables that occur after production of the binder system and the fiberglass product such as tear strength, formaldehyde emission, and/or tensile strength of the fiberglass product. The monitored process variables can also include variables that occur during production of the binder system and/or the fiberglass product such as atmospheric humidity and/or temperature and/or a temperature of the fibers during application of the binder system. As such, the monitored process variables can include variables that are acquired before, during, and/or after the binder system and/or fiberglass produced are produced. Any one or combination of two or more process variables can be used to determine or estimate the desired or preferred composition for the binder system based on the particular monitored process variable or combination of monitored process variables.

The particular monitored process variable(s) used to determine or estimate the desired or preferred composition of the binder system can be the most recently monitored process variables, monitored process variables acquired prior or previous in time as compared to the most recently acquired monitored process variables, or a combination thereof. Preferably, at least one of the monitored process variables used to determine or estimate the desired or preferred binder composition is the most recently acquired monitored process variable for that particular process condition, e.g., the most recent fiber temperature rather than a previously acquired fiber temperature.

Illustrative process variables can include, but are not limited to, press speed, temperature of the fibers, a size of the fibers, a shape of the fibers, the particular composition of the fibers, e.g., glass, polymeric, and/or organic, an age of the fibers, environmental or atmospheric conditions such as ambient temperature, ambient humidity, and/or ambient pressure, coating or application rate of the binder system to the fibers, fiberglass product cure speed, fiberglass product cure temperature, pressure applied to the fibers during production of the fiberglass product, fiberglass product density, fiberglass product thickness, formaldehyde emissions during production of the binder system and/or from the fiberglass product (when at least one resin contains formaldehyde), tear strength of the fiberglass product, dry tensile strength of the fiberglass product, wet tensile strength of the fiberglass product, thickness of the fiberglass product, the particular type of fiberglass product such as fiberglass mat, fiberglass insulation, or fiberglass batting, moisture resistance of the finished fiberglass product, dimensional stability of the fiberglass product, appearance (such as color) of the fiberglass product, the composition of the first resin, the composition of the second resin, or any combination thereof.

If two or more process conditions are monitored, the two or more process conditions can both be determined at the same point in time or different points in time with respect to one another. For example, the environmental temperature can be measured periodically, e.g., about once every hour, such as the “top” of the hour, and the environmental humidity can also be measured periodically but at different times than the environmental temperature, e.g., every 30 minutes past the hour or at the “bottom” of the hour. In another example, two or more process conditions, e.g., substrate temperature and moisture content of the substrate, can be measured periodically at the same time, e.g., every 15 minutes. In another example, two or more process conditions that can require monitoring at different points in time with respect to one another can include, but are not limited to, fiber temperature when contacted with the binder system and mat tear strength of the finished fiberglass product. For example, the mat tear strength of a finished product cannot be measured until the finished product is produced and the temperature of the fibers of that particular finished product cannot be measured after the finished product is produced. As such, both the temperature of the fibers and the mat tear strength of the finished product that includes those fibers would require monitoring those respective properties at different points in time with respect to one another. However, monitoring the temperature of the fibers and monitoring the mat tear strength of a finished product that does not include the fibers being monitored could be carried out at the same time or substantially the same time.

Production of a first fiberglass product having one or more desired, acceptable, and/or required properties can require a first binder system having a first weight ratio of the first resin to the second resin. If one or more process variables change, the weight ratio of the first resin to the second resin may require adjustment or change in order to maintain production of the first fiberglass product and/or the process of making the fiberglass product having similar or substantially similar properties or characteristics. For example, a first fiberglass mat having a first thickness (first fiberglass product) that requires a particular cure time or cure speed can be produced. A second fiberglass mat (second fiberglass product) having a second thickness, which differs from the first thickness, can also be produced. To produce the second fiberglass product having similar or substantially similar properties or characteristics as compared to the first fiberglass product may require contacting the plurality of fibers with a second binder system having a different weight ratio of the first resin to the second resin, as compared to the first binder system. As such, varying the weight ratio of the first and second resins in the binder system, based at least in part on the monitored process variable(s), e.g., the thickness of the second fiberglass product, can be used to produce fiberglass products having differing thickness, but otherwise have similar or substantially similar properties such as cure speed.

The particular fiberglass product, the binder system preparation equipment, binder system application equipment, fiberglass product forming equipment, binder system curing equipment, and/or other factors can influence or dictate what the monitored process variables should be in order to estimate or determine the particular or preferred composition of the binder system. For example, for a binder system containing formaldehyde, the monitored process variables can include, but are not limited to, the level of formaldehyde emissions observed during production of the fiberglass product and/or from the formed fiberglass product, the binder system coating or application rate onto the plurality of fibers, the amount of binder system applied to the fibers, and/or a temperature of the fibers. One or more of these monitored process variables, alone or in conjunction with one another and/or other process variables, can then be evaluated to estimate or determine the preferred composition of the binder system for producing the fiberglass product under the monitored process variables.

Due to the wide range of potential process variables that can be monitored, a wide range of different sensors and/or sensors configured to monitor multiple process variables can be used to monitor one or any combination of process variables. Illustrative sensors or detectors can include, but are not limited to, press speed sensors, moisture sensors, temperature sensors, fiber size and/or shape sensors, fiber age and/or condition sensors, binder system coating or application rate sensors, cure speed sensors, cure temperature sensors, product density sensors, product thickness sensors, formaldehyde emission sensors, fiberglass product tear strength sensors or testing equipment, dry and/or wet tensile strength sensors or testing equipment, fiberglass product thickness or other dimensional sensors, particular type of fiberglass product sensors, sensors and/or testing equipment for determining fiberglass product moisture resistance, dimensional stability of the product, and the like. For example, flow meters or flow control devices can be used to monitor a flow rate of the first resin, second resin, the binder system, and/or the binder system when applied to the plurality of fibers. The temperature sensors can be used to monitor a temperature of the environment, the fibers, the first resin, the second resin, the binder system, the finished fiberglass product, and the like. The fiber line speed sensors can be used to measure a time required for the fibers to travel a given distance through or down a product production line, e.g., a conveyor. Press rate sensors can monitor the speed or elapsed time between introduction of a first plurality of fibers to the press, pressing of the first plurality of fibers, removal of the fiberglass product, and introduction of a second plurality of fibers to the press. The formaldehyde emission sensors can monitor an amount of formaldehyde emitted into the environment from the first resin, the second resin, the binder, the fibers containing the binder, and/or the finished product. Another method that can be used to monitor one or more process variables can be to manually monitor the process variable(s). For example, a person or personnel can note the particular fiberglass product being produced, the press rate, and the like.

The first and second resins can be any type of resin suitable for bonding, adhering, gluing, or otherwise securing the plurality of fibers to one another to produce the fiberglass product. Illustrative resins can include, but are not limited to, aldehyde containing or aldehyde based resins; a mixture of Maillard reactants; a pre-reacted product of Maillard reactants; a reaction product of Maillard reactants; a copolymer of one or more vinyl aromatic derived units and at least one of maleic anhydride and maleic acid; a copolymer modified by reaction with one or more base compounds, where the copolymer includes one or more unsaturated carboxylic acids, one or more unsaturated carboxylic anhydrides, or a combination thereof and one or more vinyl aromatic derived units; a polyamide-epichlorhydrin polymer; an adduct or polymer of styrene, at least one of maleic anhydride and maleic acid, and at least one of an acrylic acid and an acrylate; a polyacrylic acid based binder; polyvinyl acetate; polymeric methylene diisocyanate (“pMDI”); or any combination thereof.

Illustrative aldehyde containing or aldehyde based resins can include, but are not limited to, urea-aldehyde resins, melamine-aldehyde resins, phenol-aldehyde resins, resorcinol-aldehyde polymers, or combinations thereof. Combinations of aldehyde based resins can include, for example, melamine-urea-aldehyde, phenol-urea-aldehyde, phenol-melamine-aldehyde, urea-resorcinol-aldehyde, and the like.

The aldehyde component of the aldehyde-containing resins can include any suitable aldehyde or combination of aldehydes. The aldehyde component can include a variety of substituted and unsubstituted aldehyde compounds. Illustrative aldehyde compounds can include the so-called masked aldehydes or aldehyde equivalents, such as acetals or hemiacetals. Specific examples of suitable aldehyde compounds can include, but are not limited to, formaldehyde, acetaldehyde, propionaldehyde, butyraldehyde, furfuraldehyde, benzaldehyde, or any combination thereof. As used herein, the term “formaldehyde” can refer to formaldehyde, formaldehyde derivatives, other aldehydes, or combinations thereof. Preferably, the aldehyde component is formaldehyde.

Formaldehyde for making suitable formaldehyde containing resins is available in many forms. Paraform (solid, polymerized formaldehyde) and formalin solutions (aqueous solutions of formaldehyde, sometimes with methanol, in 37%, 44%, or 50% formaldehyde concentrations) are commonly used forms. Formaldehyde gas is also available. Any of these forms is suitable for use in preparing a formaldehyde containing resin.

The urea component of a urea-aldehyde resin can be provided in many forms. For example, solid urea, such as prill, and/or urea solutions, typically aqueous solutions, are commonly available. Further, the urea component can be combined with another moiety, for example, formaldehyde and/or urea-formaldehyde adducts, often in aqueous solution. Any form of urea or urea in combination with formaldehyde can be used to make a urea-formaldehyde resin. Both urea prill and combined urea-formaldehyde products can be used. Suitable urea-formaldehyde resins can be prepared from urea and formaldehyde monomers or from urea-formaldehyde precondensates in manners well known to those skilled in the art. Illustrative urea-formaldehyde products can include, but are not limited to, Urea-Formaldehyde Concentrate (UFC). These types of products can be as discussed and described in U.S. Pat. Nos. 5,362,842 and 5,389,716, for example. Any of these forms of urea, alone or in any combination, can be used to prepare a urea-aldehyde polymer.

Urea-formaldehyde resins can include from about 45% to about 70%, and preferably, from about 55% to about 65% non-volatiles, generally have a viscosity of about 50 centipoise (cP) to about 600 cP, preferably about 150 cP to about 400 cP. Urea-formaldehyde resins can have a pH of about 6 to about 9 or about 7 to about 9, or preferably about 7.5 to about 8.5. Urea-formaldehyde polymers can have a free formaldehyde level of less than about 5%, less than about 4%, or less than about 3.0%. Urea-formaldehyde resins can also have a water dilutability of about 1:1 to about 100:1, preferably about 5:1 and above. Many suitable urea-formaldehyde resins are commercially available. Urea-formaldehyde resins such as the types sold by Georgia Pacific Chemicals LLC (e.g. GP® 2928 and GP® 2980) for glass fiber mat applications, those sold by Hexion Specialty Chemicals, and by Arclin Company can be used.

The viscosity of the first and second resins, additives, binder compositions, and the like, discussed and described herein, can be determined using a Brookfield Viscometer at a temperature of 25° C. For example, the Brookfield Viscometer can be equipped with a small sample adapter such a 10 mL adapter and the appropriate spindle to maximize torque such as a spindle no. 18.

In preparing a urea-aldehyde resin, the formaldehyde and the urea component can be reacted in an aqueous mixture under alkaline conditions using known techniques and equipment. The urea -aldehyde polymer can be made using a molar excess of formaldehyde (along with any other reactive aldehyde component(s)) relative to the urea component, e.g., melamine The molar ratio of formaldehyde to urea (F:U) in the urea -formaldehyde polymer can range from about 0.3:1 to about 6:1, about 0.5:1 to about 4:1, about 1:1 to about 5:1, about 1.1:1 to about 6:1, from about 1.3 to about 5:1, or from about 1.5:1 to about 4:1. When synthesized, such resins typically contain a low level of residual “free” urea component and a much larger amount of residual “free,” i.e. unreacted formaldehyde. Prior to any formaldehyde scavenging, the urea -formaldehyde resin can be characterized by a free formaldehyde content ranging from about 0.2 wt % to about 18 wt % of the aqueous urea-formaldehyde resin.

The phenol component of a phenol-aldehyde resin can include a variety of substituted phenolic compounds, unsubstituted phenolic compounds, or any combination of substituted and/or unsubstituted phenolic compounds. For example, the phenol component can be phenol itself (i.e. mono-hydroxy benzene). Examples of substituted phenols can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols such as catechol, resorcinol, hydroquinone, bis-phenol A and bis-phenol F also can also be used.

Specific examples of suitable phenolic compounds (phenol components) for replacing a portion or all of the phenol used in preparing a phenol-aldehyde polymer can include, but are not limited to, bis-phenol A, bis-phenol F, o-cresol, m-cresol, p-cresol, 3,5-5 xylenol, 3,4-xylenol, 3,4,5-trimethylphenol, 3-ethyl phenol, 3,5-diethyl phenol, p-butyl phenol, 3,5-dibutyl phenol, p-amyl phenol, p-cyclohexyl phenol, p-octyl phenol, 3,5 dicyclohexyl phenol, p-phenyl phenol, p-phenol, 3,5-dimethoxy phenol, 3,4,5 trimethoxy phenol, p-ethoxy phenol, p-butoxy phenol, 3-methyl-4-methoxy phenol, p-phenoxy phenol, naphthol, anthranol and substituted derivatives thereof. Preferably, about 80 wt % or more, about 90 wt % or more, or about 95 wt % or more of the phenol component can include phenol (monohydroxybenzene).

In preparing a phenol-aldehyde resin, the formaldehyde and the phenol component can be reacted in an aqueous mixture under alkaline conditions using known techniques and equipment. The phenol-aldehyde polymer can be made using a molar excess of formaldehyde (along with any other reactive aldehyde component(s)) relative to the phenol component, e.g., phenol. The molar ratio of formaldehyde to phenol (F:P) in the phenol-formaldehyde polymer can range from about 0.8:1 to about 6:1, about 0.8:1 to about 4:1, about 1.1:1 to about 6:1, from about 1.3 to about 5:1, or from about 1.5:1 to about 4:1. When synthesized, such polymers typically contain a low level of residual “free” phenol component and a much larger amount of residual “free,” i.e. unreacted formaldehyde. Prior to any formaldehyde scavenging, the phenol-formaldehyde polymer can be characterized by a free formaldehyde content ranging from about 0.2 wt % to about 18 wt % of the aqueous phenol-formaldehyde polymer.

Suitable phenol-formaldehyde resins can be as discussed and described in U.S. Patent Application Publication Nos. 2008/0064799 and 2008/0064284. Other phenol-formaldehyde resins can be prepared under acidic reaction conditions, such as novolac resins and inverted novolac resins. Suitable novolac resins and inverted novolac resins can be as discussed and described in U.S. Pat. Nos. 5,670,571 and 6,906,130, and U.S. Patent Application Publication No. 2008/0280787.

The melamine component of a melamine-aldehyde polymer can be provided in many forms. For example, solid melamine, such as prill, and/or melamine solutions can be used. Although melamine is specifically mentioned, the melamine can be totally or partially replaced with other aminotriazine compounds. Other suitable aminotriazine compounds can include substituted melamines, or cycloaliphatic guanamines, or mixtures thereof. Substituted melamines include the alkyl melamines and aryl melamines which can be mono-, di-, or tri-substituted. In the alkyl substituted melamines, each alkyl group can contain 1-6 carbon atoms and, preferably 1-4 carbon atoms. Typical examples of some of the alkyl-substituted melamines are monomethyl melamine, dimethyl melamine, trimethyl melamine, monoethyl melamine, and 1-methyl-3-propyl-5-butyl melamine. In the aryl-substituted melamines, each aryl group can contain 1-2 phenyl radicals and, preferably, 1 phenyl radical. Typical examples of an aryl-substituted melamines are monophenyl melamine and diphenyl melamines.

In preparing a melamine-aldehyde resin, the formaldehyde and the melamine component can be reacted in an aqueous mixture under alkaline conditions using known techniques and equipment. The melamine-aldehyde resin can be made using a molar excess of formaldehyde (along with any other reactive aldehyde component(s)) relative to the melamine component, e.g., melamine. The molar ratio of formaldehyde to melamine (F:M) in the melamine-formaldehyde resin can range from about 0.3:1 to about 6:1, about 0.5:1 to about 4:1, about 0.8:1 to about 5:1, about 1.1:1 to about 6:1, from about 1.3 to about 5:1, or from about 1.5:1 to about 4:1. When synthesized, such resins typically contain a low level of residual “free” melamine component and a much larger amount of residual “free,” i.e. unreacted formaldehyde. Prior to any formaldehyde scavenging, the melamine-formaldehyde resin can be characterized by a free formaldehyde content ranging from about 0.2 wt % to about 18 wt % of the aqueous melamine-formaldehyde resin.

Similar to urea-formaldehyde resins, melamine-formaldehyde and phenol-formaldehyde resins can be prepared from melamine or phenol monomers and formaldehyde monomers or from melamine-formaldehyde or phenol-formaldehyde precondensates. Phenol and melamine reactants, like the urea and formaldehyde reactants are commercially available in many forms and any form that can react with the other reactants and does not introduce extraneous moieties deleterious to the desired reaction and reaction product can be used in the preparation of the resins. Suitable phenol-formaldehyde resins and melamine-formaldehyde resins can include those sold by Georgia Pacific Chemicals LLC (e.g. GP® 2894 and GP® 4878, respectively). These polymers are prepared in accordance with well known methods and contain reactive methylol groups which upon curing form methylene or ether linkages. Such methylol-containing adducts may include N,N′-dimethylol, dihydroxymethylolethylene; N,N′bis(methoxymethyl), N,N′-dimethylolpropylene; 5,5-dimethyl-N,N′dimethylolethylene; N,N′-dimethylolethylene; and the like.

Illustrative resorcinol containing resin can include, but are not limited to resorcinol-aldehyde resins, such as resorcinol-formaldehyde, phenol-resorcinol-aldehyde resins, such as phenol-formaldehyde-resorcinol resins, resorcinol terminated urea-formaldehyde resins, and the like, or any combination. An illustrative resorcinol-formaldehyde resin can include formaldehyde-starved novolac resorcinol-formaldehyde resins that have excess free resorcinol, i.e. a concentration of free resorcinol that exceeds the concentration of free formaldehyde, and thus contribute free resorcinol to the reaction of the A-stage resin. Suitable resorcinol resins include GP® 4221, a resorcinol/formaldehyde resin having an excess free resorcinol, available from Georgia-Pacific Chemicals LLC. Any suitable form of resorcinol can be used. For example, the resorcinol can be in the form of resorcinol solids, in aqueous or organic solutions, or any combination thereof. For resorcinol-aldehyde polymers, when the aldehyde in the resin is formaldehyde, the molar ratio of resorcinol to formaldehyde can range from about 0.6:1 to about 2:1 or about 1:1 to about 1.5:1. The amount of resorcinol can range from about 0.1 wt % to about 10 wt %, based on the amount of formaldehyde.

The resorcinol containing resins can be combined with one or more modifiers to produce a modified resorcinol containing resin. Illustrative modifiers that can be used to produce a modified resorcinol containing resin can include, but are not limited to, latexes, styrene maleic anhydride, or a combination thereof. Illustrative latexes can include, but are not limited to, vinylpyridine-styrene butadiene resins, polybutadiene dispersions, styrene-butadiene latexes, natural rubber latex, or any combination thereof. Illustrative processes for producing resorcinol containing resins can be as discussed and described in U.S. Pat. Nos. 2,385,372; 2,488,495; 2,489,336; 3,476,706; 3,839,251; 3,919,151; 4,032,515; 4,314,050; 4,373,062; 4,376,854; 4,608,408; and 6,541,576, 7,049,387; and 7,642,333.

The mixture of Maillard reactants can include, but is not limited to, a source of a carbohydrate (carbohydrate reactant) and an amine reactant capable of participating in a Maillard reaction with the carbohydrate reactant. In another example, the mixture of Maillard reactants can include a partially pre-reacted mixture of the carbohydrate reactant and the amine reactant. The extent of any pre-reaction can preserve the ability of the mixture of Maillard reactants to be blended with any other components desired to be added into composition such as one or additives.

The source of the carbohydrate can include one or more reactants having one or more reducing sugars, one or more reactants that yields one or more reducing sugars under thermal curing conditions, or a combination thereof. A reducing sugar can be a sugar that contains aldehyde groups, or can isomerize, i.e. tautomerize, to contain aldehyde groups. Such aldehyde groups are reactive with an amino group (amine reactant) under Maillard reaction conditions. Usually such aldehyde groups can also be oxidized with, for example, Cu⁺² to afford carboxylic acids. The carbohydrate reactant can optionally be substituted with other functional groups, such as with hydroxy, halo, alkyl, alkoxy, and the like. The carbohydrate source can also possess one or more chiral centers. The carbohydrate source can also include each possible optical isomer at each chiral center. Various mixtures, including racemic mixtures, or other diastereomeric mixtures of the various optical isomers of any such carbohydrate source, as well as various geometric isomers thereof, can be used.

The carbohydrate source can be a monosaccharide in its aldose or ketose form, including a triose, a tetrose, a pentose, a hexose, or a heptose; or a polysaccharide, or any combination thereof. The carbohydrate reactant can also be used in combination with a non-carbohydrate polyhydroxy reactant. Examples of non-carbohydrate polyhydroxy reactants can include, but are not limited to, trimethylolpropane, glycerol, pentaerythritol, polyvinyl alcohol, partially hydrolyzed polyvinyl acetate, fully hydrolyzed polyvinyl acetate, and mixtures thereof.

The amine reactant capable of participating in a Maillard reaction with the source of the carbohydrate can be a compound possessing an amino group. The compound can be present in the form of an amino acid. The free amino group can also be derived from a protein where the free amino groups are available in the form of, for example, the e-amino group of lysine residues, and/or the a-amino group of the terminal amino acid. The amine reactant can also be formed separately or in situ by using a polycarboxylic acid ammonium salt reactant. Ammonium salts of polycarboxylic acids can be generated by neutralizing the acid groups of a polycarboxylic acid with an amine base, thereby producing polycarboxylic acid ammonium salt groups. Complete neutralization, i.e. about 100%, calculated on an equivalents basis, can eliminate any need to titrate or partially neutralize acid groups in the polycarboxylic acid(s) prior to binder formation. However, it is expected that less-than-complete neutralization also would not inhibit formation of the composition. To reiterate, neutralization of the acid groups of the polycarboxylic acid(s) can be carried out either before or after the polycarboxylic acid(s) is mixed with the carbohydrate(s).

Suitable polycarboxylic acids can include dicarboxylic acids, tricarboxylic acids, tetracarboxylic acids, pentacarboxylic acids, and the like, monomeric polycarboxylic acids, anhydrides, and any combination thereof, as well as polymeric polycarboxylic acids, anhydrides, and any combination thereof. Preferably, the polycarboxylic acid ammonium salt reactant is sufficiently non-volatile to maximize its ability to remain available for reaction with the carbohydrate reactant of a Maillard reaction. Again, partially pre-reacting the mixture of the source of the carbohydrate and the amine reactant can expand the list of suitable amine reactants, including polycarboxylic acid ammonium salt reactants. In another example, polycarboxylic acid ammonium salt reactants can be substituted with other chemical functional groups. Illustrative monomeric polycarboxylic acids can include, but are not limited to, unsaturated aliphatic di and/or tricarboxylic acids, saturated aliphatic di and/or tricarboxylic acids, aromatic di and/or tricarboxylic acids, unsaturated cyclic di and/or tricarboxylic acids, saturated cyclic di di and/or tricarboxylic acids, hydroxy-substituted derivatives thereof, and the like. It should be noted that any such polycarboxylic acids can be optionally substituted, such as with hydroxy, halo, alkyl, alkoxy, and the like.

The amine base for reaction with the polycarboxylic acid can include, but is not limited to, ammonia, a primary amine, i.e., NH₂R¹, and a secondary amine, i.e., NHR¹R², where R′ and R² are each independently selected from the group consisting of: an alkyl, a cycloalkyl, an alkenyl, a cycloalkenyl, a heterocyclyl, an aryl, and a heteroaryl group. The amine base can be volatile or substantially non-volatile under conditions sufficient to promote reaction among the mixture of Maillard reactants during any partial pre-reaction or during thermal cure of the composition. Suitable amine bases can include, but are not limited to, a substantially volatile base, a substantially non-volatile base, or a combination thereof. Illustrative substantially volatile bases can include, but are not limited to, ammonia, ethylamine, diethylamine, dimethylamine, ethylpropylamine, or any combination thereof. Illustrative substantially non-volatile bases can include, but are not limited to, aniline, 1-naphthylamine, 2-naphthylamine, para-aminophenol, or any combination thereof.

One particular example of the mixture of Maillard reactants can include a mixture of aqueous ammonia, citric acid, and dextrose (glucose). In this mixture, the ratio of the number of molar equivalents of acid salt groups present on the polycarboxylic, citric acid reactant (produced upon neutralization of the —COOH groups of the citric acid by ammonia) to the number of molar equivalents of hydroxyl groups present on the carbohydrate reactant(s) can range from about 0.04:1 to about 0.15:1. After curing, this formulation results in a water-resistant, cured thermoset binder. Thus, in one embodiment, the number of molar equivalents of hydroxyl groups present on the dextrose, carbohydrate reactant can be about twenty five-fold greater than the number of molar equivalents of acid salt groups present on the polycarboxylic, citric acid reactant. In another embodiment, the number of molar equivalents of hydroxyl groups present on the dextrose carbohydrate reactant is about ten-fold greater than the number of molar equivalents of acid salt groups present on the polycarboxylic citric acid reactant. In yet another embodiment, the number of molar equivalents of hydroxyl groups present on the dextrose carbohydrate reactant is about six-fold greater than the number of molar equivalents of acid salt groups present on the polycarboxylic citric acid reactant.

The aldehyde based binder(s) and/or the Maillard reactant based binder can be modified by combining with one or more modifiers. The modifier can be or include the copolymer of one or more vinyl aromatic derived units and at least one of maleic anhydride and maleic acid, optionally modified by reaction with one or more base compounds. In another example, the modifier can be or include an adduct of styrene, at least one of maleic anhydride and maleic acid, and at least one of an acrylic acid and an acrylate. In another example, the modifier can be or include the one or more latexes. In another example, the modifier can include two or more of: (1) a copolymer comprising one or more vinyl aromatic derived units and at least one of maleic anhydride and maleic acid; (2) an adduct of styrene, at least one of maleic anhydride and maleic acid, and at least one of an acrylic acid and an acrylate; and (3) one or more latexes. Illustrative mixtures, pre-reacted mixtures, and reaction products of Maillard reactants can be as discussed and described in U.S. Patent Application Publication No. 2009/0301972 and 2011/0060095.

The copolymer of one or more vinyl aromatic derived units and at least one of maleic anhydride and maleic acid can be produced using any suitable reactants. Similarly, The copolymers that can include one or more unsaturated carboxylic acids, one or more unsaturated carboxylic anhydrides, or a combination thereof, one or more vinyl aromatic derived units, and/or one or more base compounds can be produced using any suitable reactants. Illustrative vinyl aromatic derived units can include, but are not limited to, styrene, alpha-methylstyrene, vinyl toluene, and combinations thereof. Preferably, the vinyl aromatic derived units are derived from styrene and/or derivatives thereof. More preferably, the vinyl aromatic derived units are derived from styrene to produce a styrene maleic anhydride (acid) or “SMA” copolymer. Suitable SMA copolymers include resins that contain alternating styrenic and maleic anhydride (acid) monomer units, arranged in random, alternating, and/or block forms. The copolymer that includes one or more unsaturated carboxylic acids, one or more unsaturated carboxylic anhydrides, or a combination thereof, one or more vinyl aromatic derived units, and one or more amines can be as discussed and described in U.S. Patent Application Publication Nos. 2011/0165398 and 2012/0064323.

Polyamide-epichlorhydrin polymers can be made by the reaction of epichlorohydrin and a polyamide under basic conditions (i.e. a pH between about 7 to about 11). The resulting polymer can then be contacted with an acid to stabilize the product. See, e.g., U.S. Pat. Nos. 3,311,594 and 3,442,754. Unreacted epichlorohydrin in the product can be hydrolyzed by the acid to 1,3-dichloro-2-propanol(1,3-DCP), 3-chloro-1,2-propanediol (CPD), and 2,3-dichloro-1-propanol(2,3-DCP). The 1,3-DCP product is the predominant hydrolysis product with CPD being formed in levels of about 10% of the 1,3-DCP and 2,3-DCP being formed in levels of about 1% of the 1,3-DCP. Although the final product can include several other types of organic chlorines (as measured by the difference between inorganic chloride and total chlorine concentrations), the 1,3-DCP and CPD concentrations can be accurately determined by C¹³ NMR and GC-MS measuring techniques known in the art. The 2,3-DCP concentrations are, however, generally below the detection limit of C¹³ NMR so 1,3-DCP and CPD are generally used as measurements for the epichlorohydrin hydrolysis products present in the polymer. Of particular utility are the polyamide-epchlorohydrin polymers, an example of which is sold under the trade names Kymene 557LX and Kymene 557H by Hercules, Inc. and AMRES® from Georgia-Pacific Resins, Inc. These polymers and the process for making the polymers are discussed and described in U.S. Pat. Nos. 3,700,623 and 3,772,076. An extensive description of polymeric-epihalohydrin resins is given in Chapter 2: Alkaline—Curing Polymeric Amine—Epichlorohydrin by Espy in Wet Strength Resins and Their Application (L. Chan, Editor, 1994).

The adduct or polymer of styrene, at least one of maleic anhydride and maleic acid, and at least one of an acrylic acid and an acrylate can be produced using any suitable reactants. Any suitable acrylic acid or acrylate can be used such as methyl methacrylate, butyl acrylate, methacrylate, or any combination thereof. Preferably, the acrylate is methyl methacrylate (MMA). The adduct can be combined with the aldehyde based polymer, the Maillard reactants, or a combination thereof. In another example, the components of the adduct can be mixed with the aldehyde based polymer, the mixture of Maillard reactants, or a combination thereof.

The adduct can be prepared by dissolving the components of the adduct in a suitable solution. Illustrative solutions can include, but are not limited to, aqueous solutions of sodium hydroxide, ammonium hydroxide, potassium hydroxide, and combinations thereof. The solution can be heated to a temperature of about 70° C. to about 90° C. The solution can be held at the elevated temperature until the components are all at least partially in solution. The solution can then be added to the phenol-aldehyde resin, the mixture of Maillard reactants, or the combination of the phenol-aldehyde resin and the mixture of Maillard reactants.

The adduct can be prepared by combining styrene, at least one of maleic anhydride and maleic acid, and at least one of an acrylic acid and an acrylate to form a terpolymer. The amount of styrene in the adduct can range from a low of about 50 wt %, about 55 wt %, or about 60 wt % to a high of about 75 wt %, about 80 wt %, or about 85 wt %, based on the total weight of the adduct. The amount of the maleic anhydride and/or maleic acid in the adduct can range from a low of about 15 wt %, about 20 wt %, or about 25 wt % to a high of about 40 wt %, about 45 wt %, or about 50 wt %, based on the total weigh of the adduct. The amount of the acrylic acid and/or the acrylate in the adduct can range from a low of about 1 wt %, about 3 wt % or about 5 wt % to a high of about 10 wt %, about 15 wt %, or about 20 wt %, based on the total weight of the adduct.

In another example, the acrylic acid or acrylate can be combined with the copolymer of one or more vinyl aromatic derived units and at least one of maleic anhydride and maleic acid to provide the modifier. For example, combining the acrylic acid or acrylate with SMA can form a styrene maleic anhydride methyl-methacrylate terpolymer. In another example, the modifier can also include a physical mixture of styrene acrylic acid and/or styrene-acrylate copolymer and a SMA copolymer. The adduct or polymer of styrene, at least one of maleic anhydride and maleic acid, and at least one of an acrylic acid and an acrylate and the physical mixture of styrene acrylic acid and/or styrene-acrylate copolymer and a SMA copolymer can be prepared according to the processes discussed and described in U.S. Pat. No. 6,642,299.

The polyacrylic acid based binder can include an aqueous solution of a polycarboxy polymer, a monomeric trihydric alcohol, a catalyst, and a pH adjuster. The polycarboxy polymer can include an organic polymer or oligomer containing more than one pendant carboxy group. The polycarboxy polymer can be a homopolymer or copolymer prepared from unsaturated carboxylic acids including, but not limited to, acrylic acid, methacrylic acid, crotonic acid, isocrotonic acid, maleic acid, cinnamic acid, 2-methylmaleic acid, itaconic acid, 2-methylitaconic acid, α,β-methyleneglutaric acid, and the like. Other suitable polycarboxy polymers can be prepared from unsaturated anhydrides including, but not limited to, maleic anhydride, itaconic anhydride, acrylic anhydride, methacrylic anhydride, and the like, as well as mixtures thereof.

Illustrative trihydric alcohols can include, but are not limited to, glycerol, trimethylolpropane, trimethylolethane, triethanolamine, 1,2,4-butanetriol, and the like. The one or more trihydric alcohols can be mixed with other polyhydric alcohols. Other polyhydric alcohols can include, but are not limited to, ethylene, glycol, 1,3-propanediol, 1,4-butanediol, 1,6-hexanediol, 2-butene-1, erythritol, pentaerythritol, sorbitol, and the like. The catalyst can include an alkali metal salt of a phosphorous-containing organic acid; particularly alkali metal salts of phosphorous acid, hypophosphorous acid, and polyphosphoric acids. Illustrative catalysts can include, but are not limited to, sodium, sodium phosphite, potassium phosphite, disodium pyrophosphate, tetrasodium pyrophosphate, sodium tripolyphosphate, sodium hexametaphosphate, potassium phosphate, potassium polymetaphosphate, potassium polyphosphate, potassium tripolyphosphate, sodium trimetaphosphate, and sodium tetrametaphosphate, or any combination thereof. Illustrative polyacrylic acid based polymers can be as discussed and described in U.S. Pat. No. 7,026,390.

As noted above, the binder system can include the first resin and one or more additives. As also noted above, the binder system can include the first and second resins and one or more additives. Illustrative additives can include, but are not limited to, one or more catalysts, dispersants, waxes or other hydrophobic additives, water, filler material(s), extenders, surfactants, release agents, dyes, fire retardants, formaldehyde scavengers, biocides, viscosity modifiers, pH adjusters, coupling agents, lubricants, defoamers, or any combination thereof. For example, the additive can be or include an aqueous solution (white water) of polyacrylamide (PAA), amine oxide (AO), or hydroxyethylcellulose (HEC) that can be added to the first resin to produce the binder composition. In another example, a coupling agent (e.g., a silane coupling agent, such as an organo silicon oil) can also be added to the first resin to produce the binder composition. In at least one example, the one or more additives can be non-reactive with the first resin and, if present, the second resin. The one or more additives can serve to modify or alter one or more properties of the binder system. For example, a viscosity modifier can increase or decrease a viscosity of the binder system. In another example, formaldehyde scavenger can reduce an amount of free formaldehyde that may be present in the binder system.

If the binder composition includes the first resin and a one or more additives, the amount of each additive can range from a low of about 0.01 wt % to a high of 25 wt %, based on the solids weight of the first resin. For example, the amount of any given additive can range from a low of about 0.01 wt %, about 0.05 wt %, about 0.1 wt %, about 0.5 wt %, or about 1 wt % to a high of about 3 wt %, about 5 wt %, about 7 wt %, or about 9 wt %, based on the solids weight of the first resin. In another example, the amount of any given additive can range from about 0.05 wt % to about 20 wt %, about 0.5 wt % to about 15 wt %, about 1 wt % to about 20 wt %, about 1 wt % to about 13 wt %, about 2 wt % to about 10 wt %, or about 1 wt % to about 5 wt %. Additionally, for a binder system that includes the first resin and the second resin, in addition to or in lieu of adjusting an amount of the first resin and the second resin relative to one another in the binder system, the amount of one or more of the additives, if present, can be adjusted to produce a different binder system. Adjusting the amount of one or more of the additives, if present, can also at least partially account for a change in one or more of the monitored process variables.

Fiberglass mats can be manufactured in a wet-laid or dry-laid process. In a wet-laid process, chopped bundles of fibers, having suitable length and diameter, can be introduced to an aqueous dispersant medium to produce an aqueous fiber slurry, known in the art as “white water.” The white water can typically contain about 0.5 wt % fibers. The fibers can have a diameter ranging from about 0.5 μm to about 30 μm and a length ranging from about 5 mm to about 50 mm, for example. The fibers can be sized or unsized and wet or dry, as long as the fibers can be suitably dispersed within the aqueous fiber slurry.

In making non-woven fiber products, a fiber slurry, diluted or undiluted, can be introduced to a mat-forming machine that can include a mat forming screen, e.g. a wire screen or sheet of fabric, which can form a fiber product and can allow excess water to drain therefrom, thereby forming a wet or damp fiber mat. The fibers can be collected on the screen in the form of a wet fiber mat and excess water is removed by gravity and/or by vacuum assist. The removal of excess water via vacuum assist can include one or a series of vacuums.

The binder system can be applied to the non-woven mat (or other fiberglass substrate), such as by a curtain coating, spraying, or dipping, onto fibers, such as glass fibers. Excess binder system can be removed, for example under vacuum. Binder systems containing anywhere from about 1 wt % to about 99 wt % solids can be used for making fiberglass products. For example, binder systems containing somewhere between about 1 wt % and about 50 wt % solids can be used for making fiberglass products, including glass fiber products. In another example, the binder system can have a solids concentration ranging from about 5 wt % to about 45 wt %, about 10 wt % to about 40 wt %, or from about 15 wt % to about 35 wt %, based on the total weight of the binder system. In another example, the binder system can have a solids concentration ranging from a low of about 10 wt %, about 13 wt %, about 15 wt %, or about 18 wt % to a high of about 22 wt %, about 26 wt %, about 30 wt %, or about 33 wt %, based on the total weight of the binder system.

A dispersing agent can be added to the binder system in an amount ranging from about 10 ppm to about 8,000 ppm, about 100 ppm to about 5,000 ppm, or from about 200 ppm to about 1,000 ppm. The introduction of one or more viscosity modifiers can reduce settling time of the fibers and can improve the dispersion of the fibers in the aqueous solution. The amount of viscosity modifier used can be effective to provide the viscosity needed to suspend the fibers in the white water as needed to form the wet laid fiber product. The optional viscosity modifier(s) can be introduced in an amount ranging from a low of about 1 wt %, about 1.5 wt %, or about 2 wt % to a high of about 8 wt %, about 12 wt %, or about 15 wt %. For example, optional viscosity modifier(s) can be introduced in an amount ranging from about 1 wt % to about 12 wt %, about 2 wt % to about 10 wt %, or about 2 wt % to about 6 wt %. In one or more embodiments, the fiber slurry can include of from about 0.03 wt % to about 25 wt % solids. The fiber slurry can be agitated to produce a uniform dispersion of fibers having a suitable consistency.

The amount of binder system applied to the plurality of fibers, e.g. a fiberglass mat, can vary considerably. Loadings typically can range from about 3 wt % to about 45 wt %, about 10 wt % to about 40 wt %, or from about 15 wt % to about 30 wt %, of nonvolatile binder system based on the dry weight of the fiberglass product. For inorganic fibrous mats, the amount of binder system applied to a fiberglass product can normally be confirmed by measuring the percent loss on ignition (LOI) of the fiber mat product.

Once the binder system has been applied to the plurality of fibers, the binder composition can be at least partially cured or fully cured. The fiber/binder system mixture can be heated to effect final drying and at least partial curing. The duration and temperature of heating can affect the rate of processibility and handleability, degree of curing and property development of the treated substrate. The curing temperature can be within the range of from about 50° C. to about 300° C., preferably within the range of from about 90° C. to about 230° C. and the curing time will usually be somewhere between about 1 second to about 15 minutes. The curing temperature can include a temperature gradient ranging from a low of about 25° C. to a high of about 280° C., i.e. the temperature applied during the curing process can vary. In at least one specific embodiment, the curing temperature can range from about 190° C. to about 260° C. and the curing time can range from a low of about 1 second, about 2 seconds, or about 3 seconds to a high of about 9 seconds, about 12 seconds, about 15 seconds, about 20 seconds, about 25 seconds, or about 30 seconds. The binder system can exhibit a multi-stage curing profile. For example, a binder system containing an aqueous first resin and a powdered second resin can exhibit a two-stage cure profile. In other words, the aqueous first resin and the powdered second resin can cure at different times with respect to one another.

On heating, water (or other liquid) present in the binder system evaporates, and the composition undergoes curing. These processes can take place in succession or simultaneously. Curing in the present context is to be understood as meaning the chemical alteration of the composition, for example crosslinking through formation of covalent bonds between the various constituents of the composition, especially the esterification reaction between pendant carboxyl (--COOH) of modified polymer and the hydroxyl (--OH) moieties both of the modified polymer and any added polyol(s), the formation of ionic interactions and clusters, and formation of hydrogen bonds.

Alternatively or in addition to heating the fiberglass product catalytic curing can be used to cure the fiberglass product. Catalytic curing of the fiberglass product can include the addition of an acid catalyst. Illustrative acid catalysts can include, but are not limited to, ammonium chloride or p-toluenesulfonic acid.

The drying and curing of the binder system can be conducted in two or more distinct steps. For example, the fiber/binder system mixture can be first heated to a temperature and for a time sufficient to substantially dry but not to substantially cure the binder composition and then heated for a second time at a higher temperature and/or for a longer period of time to effect curing (cross-linking to a thermoset structure). Such a preliminary procedure, referred to as “B-staging”, can be used to provide a binder-treated product, for example, in roll form, which may at a later stage be fully cured, with or without forming or molding into a particular configuration, concurrent with the curing process. This makes it possible, for example, to use fiberglass products which can be molded and cured elsewhere.

In one or more embodiments above or elsewhere herein, the binder composition can be cured or crosslinked via an esterification reaction between pendant carboxyl groups of the polymers and when optional polyol(s) is added both pendant hydroxyl groups of the polymers and hydroxyl groups of the polyol(s). Additional crosslinking may occur with any additional polyol that may optionally be added to the composition. A thermal process or heat can also be used to cure the binder composition. For example, an oven or other heating device can be used to at least partially cure the binder composition. Other additives for augmenting the cross-linking of the binder composition can be introduced thereto. For example, urea and polyamino compounds, both synthetic and natural (e.g., protein sources such as soy) can be introduced to the binder composition for augmenting the cross-linking.

As used herein, the terms “curing,” “cured,” and similar terms are intended to embrace the structural and/or morphological change that occurs in a the binder composition, such as by covalent chemical reaction (crosslinking), ionic interaction or clustering, improved adhesion to the substrate, phase transformation or inversion, and/or hydrogen bonding when the binder composition is dried and heated to cause the properties of a flexible, porous substrate, such as a mat or blanket of fibers, especially glass fibers, to which an effective amount of the binder composition has been applied, to be altered. Generally, the bonding occurs at the intersection of overlapping fibers.

As used herein, the terms “fiber,” “fibrous,” “fiberglass,” “fiber glass,” “glass fibers,” and the like are refer to materials that have an elongated morphology exhibiting an aspect ratio (length to thickness) of greater than 100, generally greater than 500, and often greater than 1,000. Indeed, an aspect ratio of over 10,000 is possible. Suitable fibers can be glass fibers, natural fibers, synthetic fibers, mineral fibers, ceramic fibers, metal fibers, carbon fibers, or any combination thereof. Illustrative glass fibers can include, but are not limited to, A-type glass fibers, C-type glass fibers, E-type glass fibers, S-type glass fibers, ECR-type glass fibers, wool glass fibers, and any combination thereof. The term “natural fibers,” as used herein refers to plant fibers extracted from any part of a plant, including, but not limited to, the stem, seeds, leaves, roots, or phloem. Illustrative natural fibers can include, but are not limited to, cotton, jute, bamboo, ramie, bagasse, hemp, coir, linen, kenaf, sisal, flax, henequen, and any combination thereof. Illustrative synthetic fibers can include, but are not limited to, synthetic polymers, such as polyester, polyamide, aramid, and any combination thereof. In at least one specific embodiment, the fibers can be glass fibers that are wet use chopped strand glass fibers (WUCS). Wet use chopped strand glass fibers can be formed by conventional processes known in the art. The WUCS can have a moisture content ranging from a low of about 5%, about 8%, or about 10% to a high of about 20%, about 25%, or about 30%.

Prior to using the fibers to make a fiberglass product, the fibers can be allowed to age for a period of time. For example, the fibers can be aged for a period of a few hours to several weeks before being used to make a fiberglass product. For fiberglass mat products the fibers can typically be aged for about 3 to about 30 days. Ageing the fibers includes simply storing the fibers at room temperature for the desired amount of time prior to being used in making a fiberglass product.

In one or more embodiments, a method for binding loosely associated, non-woven mat or blanket of fibers can include, but is not limited to (1) contacting the fibers with the binder system and (2) heating the fibers/binder system to an elevated temperature, which temperature is sufficient to at least partially cure the binder system. Preferably, the binder system is cured at a temperature ranging from about 75° C. to about 300° C., usually at a temperature between about 100° C. and up to a temperature of about 250° C. The binder system can be cured at an elevated temperature for a time ranging from about 1 second to about 15 minutes. The particular curing time can depend, at least in part, on the type of oven or other heating device design and/or production or line speed.

Depending on formation conditions, the density of the fiberglass product can be varied from a relatively fluffy low density product to a higher density of about 6 to about 10 pounds per cubic foot or higher. For example, a fiber mat product can have a basis weight ranging from a low of about 0.1 pound, about 0.5 pounds, or about 0.8 pounds to a high of about 3 pounds, about 4 pounds, or about 5 pounds per 100 square feet. In another example, the fiber mat product can have a basis weight of from about 0.6 pounds per 100 square feet to about 2.8 pounds per 100 square feet, about 1 pound per 100 square feet to about 2.5 pounds per 100 square feet, or about 1.5 pounds per 100 square feet to about 2.2 pounds per 100 square feet. In another example, the fiber mat product can have a basis weight of about 1.2 pounds per 100 square feet, about 1.8 pounds per 100 square feet, or about 2.4 pounds per 100 square feet.

The fibers can represent the principal material of the fiberglass products, such as a fiberglass mat product. For example, 60 wt % to about 90 wt % of the fiberglass product, based on the combined amount of binder system and fibers can be composed of the fibers. The binder system can be applied in an amount such that the cured binder constitutes from about 1 wt % to about 40 wt % of the finished product. The binder composition can be applied in an amount such that the cured binder system constitutes a low of from about 1 wt %, about 5 wt %, or about 10 wt % to a high of about 15 wt %, about 20 wt %, or about 25 wt %, based on the combined weight of the binder system and the fibers.

Fiberglass products may be used by themselves or incorporated into a variety of products. For example, fiberglass products can be used as or incorporated into insulation batts or rolls, composite flooring, asphalt roofing shingles, siding, gypsum wall board, roving, microglass-based substrate for printed circuit boards, battery separators, filter stock, tape stock, carpet backing, air filters, and as reinforcement scrim in cementitious and non-cementitious coatings for masonry.

The fiberglass mat product can have a thickness ranging from a low of about 0.25 mm (10 mils), about 0.63 mm (25 mils), about 0.76 mm (30 mils), about 1.3 mm (50 mils), or about 1.9 mm (75 mils) to a high of about 6.4 mm (250 mils), about 12.7 mm (500 mils), about 19 mm (750 mils), or about 25.4 mm (1,000 mils). For example, the fiberglass mat product can have a thickness of about 0.5 mm (20 mils), about 1 mm (39 mils) about, or about 2 mm (79 mils). In another example, the fiberglass mat product can have a thickness of from about 0.5 mm (20 mils) to about 1.3 mm (50 mils), about 0.6 mm (25 mils) to about 1.1 mm (45 mils), or about 0.8 mm (30 mils) to about 1 mm (40 mils).

In one or more embodiments, the fiberglass mats can have a basis weight (BW) ranging from a low of about 1.5 lbs/100 ft², about 1.6 lbs/100 ft², about 1.7 lbs/100 ft², or about 1.8 lbs/100 ft² to a high of about 2 lbs/100 ft², about 2.1 lbs/100 ft², about 2.2 lbs/100 ft², or about 2.3 lbs/100 ft². For example, the fiberglass mats can have a basis weight of about 1.65 lbs/100 ft², about 1.75 lbs/100 ft², about 1.85 lbs/100 ft², about 1.95 lbs/100 ft², or about 2.1 lbs/100 ft².

The FIGURE depicts an illustrative system 100 for varying a composition of a binder system for use in making one or more fiberglass products 170, according to one or more embodiments. The system 100 can include one or more resin vessels (two are shown 105, 110), one or more flow meters or flow control devices (two are shown 115, 120), one or more mixers (one is shown 125), one or more binder system applicators or binder system application units (one is shown 130), and one or more fiber product forming units (one is shown 160). The system 100 can also include one or more process variable monitors (one is shown 135) and one or more control systems or controllers (one is shown 140).

A first resin 106 and a second resin 111 can be stored or otherwise contained in the first and second resin vessels 105, 110, respectively. The first resin via line 107 and the second resin via line 113 can be introduced to the mixer 125. The first and second resins 106, 111 can be mixed, blended, or otherwise combined with one another to produce a first binder system via line 127. The first and/or second flow control devices 115, 120 can control or adjust the amounts of the first and second resins introduced via lines 107, 111, respectively, to the mixer 125. The first binder system via line 127 can be introduced to the binder system application unit 130, which can distribute or disperse the first binder system 145 such that the first binder system 145 contacts a plurality fibers 150 to produce a first substrate/binder system mixture or “first mixture” 153. The first mixture 153 can be introduced, e.g., the first conveyor 155, to the fiber product forming unit 160. The fiber product forming unit 160 can form or shape the first mixture 153 to a desired dimension and at least partially cure the first binder system to produce a first fiber product 170. The first fiber product 170 can be recovered from the composite product forming unit 160 and transported, e.g., via conveyor 165, to further processing, storage, or the like.

The first and second flow control devices 115, 120 can be manually controlled or adjusted and/or automatically controlled or adjusted. For example, personnel can manually adjust the first and/or second control devices 115, 120 to control the amount of the first and/or second resins via lines 106, 111, respectively, that can be introduced via lines 107, 113, respectively, to the mixer 125. In another example, the control system 140 can automatically adjust the first and/or second flow control devices 115, 120 to control the amount of the first and/or second resins via lines 106, 111, respectively, that can be introduced via lines 107, 113, respectively, to the mixer 125. Adjusting the flow rate of the first and/or second resins 106, 111 through the first and second flow control devices 115, 120, respectively, the control system 140 and/or manually can be based, at least in part, on one or more monitored process variables.

The process variable monitor 135 can estimate one or more process variables before, during, and/or after production of the fiber product 170. The process variable monitor 135 can include, for example, a temperature sensor, a formaldehyde emission sensor, or other sensor capable of monitoring one or more process variables. Alternatively or in addition to the process variable monitor 135 one or more personnel can estimate, measure, or otherwise determine one or more process variables. As such, the one or more process variables can be monitored via the process variable monitor 135, personnel, or a combination thereof.

The process variable monitor 135 can transmit the estimated or monitored process variable(s) via line 137 to the control system 140. The control system 140 can evaluate the monitored process variable(s) to determine an appropriate composition for the binder system 145 that can be based, at least in part, on the monitored process variables introduced thereto via line 137. The control system 140 can control the amount of the first resin 106 in line 107 and/or the amount of the second resin 111 in line 113 via lines 141 and 143, respectively. The lines 141 and 143 can be physical connections, e.g., a wire, cable, or other physical device, and/or a wireless connection, e.g., sound, light, and/or radio frequency energy. A signal can be output via lines 141 and/or 143 to communicate to the first and/or second flow control device 115, 120 any adjustment, if any, in the amount of the first and/or second resin via lines 107, 113 introduced to the mixer 125.

If the evaluation of the one or more monitored process variables indicates a change in the composition of the first binder system should be changed, then a second binder system can be produced. The amount of the first resin 107 and/or the amount of the second resin via line 113 used to produce the first binder system via line 127 can be adjusted in response to the one or more monitored process variables and introduced to the mixer 125. The differing amount(s) of the first and/or second resins via lines 107, 113 can be mixed, blended, or otherwise combined with one another to produce the second binder system via line 127. The second binder system in line 127 can have a different weight ratio of the first resin to the second resin as compared to the first binder system. The second binder system via line 127 can then be used to produce one or more second fiber products. More particularly, the second binder system via line 127 can be introduced to the binder system application unit 130, which can distribute or disperse the second binder system 145 such that the second binder system 145 contacts the plurality of fibers 150 to produce a second substrate/binder system mixture or “second mixture” (not shown). The second mixture can be introduced, e.g., the first conveyor 155, to the fiber product forming unit 160 similar to the first mixture 153. The fiber product forming unit 160 can form or shape the second mixture 153 to a desired dimension and at least partially cure the second binder system to produce a second fiber product (not shown). The second fiber product can be recovered from the composite product forming unit 160 and transported, e.g., via conveyor 165, to further processing, storage, or the like, similar to the first fiber product 170.

The first and second resin vessels 105, 110, respectively, can be an open vessel or a closed vessel. The first and second resin vessels 105, 110 can include one or more mixing devices such as one or more mechanical/power mixers and/or acoustic mixers such as sonic mixers. The first and second resin vessels 105, 110 can include a cooling and/or heating jacket disposed about and/or coil disposed therein for maintaining a temperature of the resin at a desired temperature or within a desired temperature range. In another example, the first and/or second resin vessels 105, 110 can be a taker truck or other transportation vehicle such as a rail car. In another example, the first and/or second resin vessels 105, 110 can be a reaction vessel in which the first and/or second resins 106, 111 is produced by reacting two or more reactants with one another to produce the first and/or second resin 106, 111, respectively.

The flow control devices 115, 120 can be any suitable device, system, or combination of devices and/or systems adapted or configured to control the amount of the first and second resins in lines 107, 111, respectively, introduced to the mixer 125. Illustrative flow control devices can include, but are not limited to, valves, nozzles, pumps, and the like. For example, valves suitable for use as the flow control devices 115, and/or 120 can include ball valves, gate valves, needle valves, butterfly valves, globe valves, and the like.

The mixer 125 for combing the first and the second resins introduced via lines 107, 111, respectively can include any device, system, apparatus, or any combination of devices, systems, and/or apparatus suitable for batch, intermittent, and/or continuous mixing of two or more components. The mixer 125 can be or include one or more open vessels or containers. For example, the mixer can be or include one or more enclosed bodies or containers capable of carrying out the mixing under vacuum, at atmospheric pressure, and/or at a pressure greater than atmospheric pressure. The mixer can also be or include one or more pipes, tubes, conduits, or other structures, capable of mixing any two or more of the components of the binder composition. For example, any two or more of the binder composition components can be mixed inline, e.g., a conduit of a binder composition delivery or application system.

Illustrative mixing, blending, or other combining device, system, apparatus, or combinations thereof can include, but is not limited to, mechanical mixer agitation, ejectors, static mixers, mechanical/power mixers, shear mixers, sonic mixers, or combinations thereof. The mixer 125 can include one or more heating jackets, heating coils, internal heating elements, cooling jacks, cooling coils, internal cooling elements, or the like, which can heat and/or cool the first and second resins and/or the binder system.

The binder system application unit 130 can include any one or more systems, devices, or combinations thereof capable of applying the binder system in line 127 to the plurality of fibers 150 to produce the first mixture 153 (and the second mixture). For example, the application unit 130 can be or include on or more nozzles that can spray, mist, drip, foam, or otherwise urge the binder system in line 127 into contact with the plurality fibers 150 to produce the first mixture 153. In another example the application unit 130 can be or include one or more brushes or other application devices capable of applying the binder system in line 127 to the plurality of fibers 150 to produce the first mixture 153. In another example, the binder system application unit 130 can be or include a vessel with one or more mixers or stirs to which the binder system via line 127 and the plurality of fibers 150 can be introduced and contacted with one another to produce the first mixture 153.

The fiber product forming unit 160 can include any one or systems, devices, or combinations thereof capable of at least partially curing the binder system. For example, the fiber product forming unit 160 can include one or more heaters or heating devices capable of heating the first mixture 153 to a desired temperature for a desired time to at least partially cure the binder system. The fiber product forming unit 160 can also be capable of shaping or otherwise controlling a final dimension or shape of the composite product. For example, the fiber product forming unit 160 can be or include a press. The press can be heated to apply heat to the furnish 153.

Embodiments of the present disclosure further relate to any one or more of the following paragraphs:

1. A method for preparing a binder system for use in producing fiberglass products, comprising: combining at least a first resin and a component to produce a first binder system, wherein the component comprises a second resin, an additive, or a combination thereof; applying at least a portion of the first binder system to a first plurality of fibers; monitoring one or more process variables; evaluating the one or more monitored process variables; and adjusting an amount of the first resin, the component, or both combined with one another in response to the evaluation of the one or more monitored process variables to produce a second binder system.

2. A method for preparing a binder system for use in producing fiber products, comprising: combining a first resin and a component to produce a first binder system, wherein the component comprises a second resin, an additive, or a combination thereof, and wherein the first binder system has a first weight ratio of the first resin to the component, based on a solids weight of the first resin and the component; contacting a first plurality of fibers with the first binder system to product a first mixture; at least partially curing the first binder system in the first mixture to produce a first fiber product; monitoring one or more process variables; evaluating the one or more monitored process variables; adjusting an amount of the first resin, the component, or both combined with one another to produce a second binder system having a second weight ratio of the first resin to the component, based on a solids weight of the first resin and the component, wherein the adjustment in the amount of the first resin, the component, or both is based, at least in part, on the evaluation of the one or more monitored process variables; contacting a second plurality of fibers with the second binder system to produce a second mixture; and at least partially curing the second binder system in the second mixture to produce a second fiber product.

3. The method according to paragraph 1, further comprising: at least partially curing the first binder system applied to the first plurality of fibers to produce a first fiberglass product; applying at least a portion of the second binder system to a second plurality of fibers; and at least partially curing the second binder system applied to the second plurality of fibers to produce a second fiberglass product.

4. The method according to paragraph 2 or 3, wherein the first fiberglass product and the second fiberglass product is in the form of a mat or insulation.

5. The method according to any one of paragraphs 2 to 4, wherein the first fiberglass product and the second fiberglass product are different from one another.

6. The method according to any one of paragraphs 1 to 5, wherein the additive is present and comprises a dispersant, a wax, water, a filler material, an extender, a surfactant, a release agent, a dye, a fire retardant, a formaldehyde scavenger, a biocide, a viscosity modifier, a pH adjuster, a coupling agent, a lubricant, a defoamer, or any combination thereof.

7. The method according to any one of paragraphs 1 to 6, wherein evaluating the one or more monitored process variables comprises comparing the one or more monitored process variables to a predetermined database containing the one or more monitored process variables.

8. The method according to any one of paragraphs 1 to 7, wherein evaluating the one or more monitored process variables comprises manipulating one or more monitored process variable to provide one or more manipulated process variables; and comparing the one or more manipulated process variables to a predetermined database containing predetermined values of the one or more manipulated process variables that was previously monitored and manipulated.

9. The method according to any one of paragraphs 1 to 8, wherein evaluating the one or more monitored process variables comprises using linear regression modeling, non-linear regression modeling, multiple linear regression modeling, multiple non-linear regression modeling, neural network modeling, or any combination thereof.

10. The method according to any one of paragraphs 1 to 9, wherein at least two process variables are monitored, the method further comprising, ranking the at least two monitored process variables with respect to one another.

11. The method according to paragraph 10, wherein the at least two monitored process variables are ranked with respect to one another based on the effect each process variable has on one or more process properties.

12. The method according to any one of paragraphs 1 to 11, wherein at least 5 process variables are monitored.

13. The method according to any one of paragraphs 1 to 12, wherein at least 10 process variables are monitored.

14. The method according to any one of paragraphs 1 to 13, wherein the one or more process variables comprises at least one of: a temperature of the plurality of fibers, a size of the plurality of fibers, a shape of the plurality of fibers, a composition of the plurality fibers, an age of the plurality of fibers, ambient temperature, ambient humidity, ambient pressure, application rate of the binder system to the first plurality of fibers, a formaldehyde emissions during production of the binder system, a composition of the first resin, a composition of the component, or any combination thereof.

15. The method according to any one of paragraphs 1 to 14, wherein the component comprises a second resin, and wherein the first resin and the second resin contain at least one different compound with respect to one another.

16. The method according to any one of paragraphs 1 to 15, wherein the component comprises a second resin, and wherein the first resin and the second resin have at least one different property with respect to one another.

17. The method according to any one of paragraphs 1 to 16, wherein the one or more process variables is monitored before the first resin and the component are combined to produce the first binder system.

18. The method according to any one of paragraphs 1 to 17, wherein the one or more process variables is monitored when the first resin and the component are combined to produce the first binder system.

19. The method according to any one of paragraphs 1 to 18, wherein the one or more process variables is monitored after the first resin and the component are combined to produce the first binder system.

20. The method according to any one of paragraphs 1 to 19, wherein at least one of the one or more process variables is monitored before the first resin and the component are combined to produce the first binder system, and at least one of the one or more process variables is monitored when the first resin and the component are combined to produce the first binder system.

21. The method according to any one of paragraphs 1 to 20, wherein at least one of the one or more process variables is monitored before the first resin and the component are combined to produce the first binder system, and at least one of the one or more process variables is monitored after the first resin and the component are combined to produce the first binder system.

22. The method according to any one of paragraphs 1 to 21, wherein at least one of the one or more process variables is monitored when the first resin and the component are combined to produce the first binder system, and at least one of the one or more process variables is monitored after the first resin and the component are combined to produce the first binder system.

23. The method according to any one of paragraphs 1 to 22, wherein at least one of the one or more process variables is monitored before the first resin and the component are combined to produce the first binder system, at least one of the one or more process variables is monitored when the first resin and the component are combined to produce the first binder system, and at least one of the one or more process variables is monitored after the first resin and the component are combined to produce the first binder system.

24. The method according to any one of paragraphs 1 to 23, wherein the one or more process variables comprises at least one of: a press speed, a temperature of the plurality of fibers, a size of the plurality of fibers, a shape of the plurality of fibers, a composition of the plurality fibers, an age of the plurality of fibers, ambient temperature, ambient humidity, ambient pressure, application rate of the binder system to the plurality of fibers, a fiberglass product cure speed, a fiberglass product cure temperature, a pressure applied to the fibers during production of the first fiberglass product, a density of the first fiberglass product, a thickness of the first fiberglass product, a formaldehyde emissions during production of the binder system, a formaldehyde emissions from the first fiberglass product, a tear strength of the first fiberglass product, a dry tensile strength of the first fiberglass product, a wet tensile strength of the first fiberglass product, a moisture resistance of the first fiberglass product, a dimensional stability of the first fiberglass product, an appearance of the first fiberglass product, a composition of the first resin, a composition of the component, or any combination thereof.

25. The method according to any one of paragraphs 1 to 24, wherein the one or more monitored process variables comprise at least a first monitored process variable and a second monitored process variable, and wherein the first and second monitored process variables are monitored at the same time or at different times with respect to one another.

26. The method according to any one of paragraphs 1 to 25, wherein the additive is present and comprises a dispersant, a wax, a filler material, an extender, a surfactant, a release agent, a dye, a fire retardant, a formaldehyde scavenger, a biocide, a viscosity modifier, a pH adjuster, a coupling agent, a lubricant, a defoamer, or any combination thereof.

27. The method according to any one of paragraphs 1 to 26, wherein the one or more monitored process variables comprises at least a first process variable and a second process variable, wherein the first process variable is monitored before the first resin and the component are combined to produce the first binder system, and wherein the second process variable is monitored after the first resin and the component are combined to produce the first binder system.

28. The method according to any one of paragraphs 1 to 27, wherein the one or more monitored process variables comprises at least a first process variable and a second process variable, wherein the first process variable is monitored before the first resin and the component are combined to produce the first binder system, and wherein the second process variable is monitored after the first binder system is at least partially cured to produce the first fiberglass product.

29. A system for producing a binder system and one or more fiber products, comprising: a first vessel in fluid communication with a first flow control device, wherein the first vessel is adapted to contain a first resin; a second vessel in fluid communication with a second flow control device, wherein the second vessel is adapted to contain a component, wherein the component comprises a second resin, an additive, or a combination thereof; a least one process variable monitor adapted to monitor one or more process variables; a control system for evaluating the one or more monitored process variables and controlling the first flow control device, the second flow control device, or both based on the evaluated one or more monitored process variables; a mixer adapted to combine the first resin and the component to produce a first binder system; and a binder application unit configured to contact at least a portion of the first binder system with a plurality of fibers to produce a binder system and fiber mixture.

30. The system according to paragraph 29, further comprising a product forming unit configured to at least partially cure the binder system in the binder system and fiber mixture to produce a fiber product.

31. The system according to paragraph 29 or 30, wherein evaluating the one or more monitored process variables comprises comparing at least one of the one or more monitored process variables to a predetermined database containing the at least one of the one or more monitored process variables.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A method for preparing a binder system for use in producing fiberglass products, comprising:
combining at least a first resin and a component to produce a first binder system, wherein the component comprises a second resin, an additive, or a combination thereof;
applying at least a portion of the first binder system to a first plurality of fibers;
monitoring one or more process variables;
evaluating the one or more monitored process variables; and
adjusting an amount of the first resin, the component, or both combined with one another in response to the evaluation of the one or more monitored process variables to produce a second binder system.

2. The method of claim 1, further comprising:
at least partially curing the first binder system applied to the first plurality of fibers to produce a first fiberglass product;
applying at least a portion of the second binder system to a second plurality of fibers; and
at least partially curing the second binder system applied to the second plurality of fibers to produce a second fiberglass product.

3. The method of claim 1, wherein the additive is present and comprises a dispersant, a wax, water, a filler material, an extender, a surfactant, a release agent, a dye, a fire retardant, a formaldehyde scavenger, a biocide, a viscosity modifier, a pH adjuster, a coupling agent, a lubricant, a defoamer, or any combination thereof.

4. The method of claim 1, wherein evaluating the one or more monitored process variables comprises comparing the one or more monitored process variables to a predetermined database containing the one or more monitored process variables.

5. The method of claim 1, wherein evaluating the one or more monitored process variables comprises manipulating one or more monitored process variables to provide one or more manipulated process variables; and comparing the one or more manipulated process variables to a predetermined database containing predetermined values of the one or more manipulated process variables that was previously monitored and manipulated.

6. The method of claim 1, wherein evaluating the one or more monitored process variables comprises using linear regression modeling, non-linear regression modeling, multiple linear regression modeling, multiple non-linear regression modeling, neural network modeling, or any combination thereof.

7. The method of claim 1, wherein at least two process variables are monitored, the method further comprising, ranking the at least two monitored process variables with respect to one another.

8. The method of claim 1, wherein at least 5 process variables are monitored.

9. The method of claim 1, wherein the component comprises a second resin, and wherein the first resin and the second resin contain at least one different compound with respect to one another.

10. The method of claim 1, wherein the component comprises a second resin, and wherein the first resin and the second resin have at least one different property with respect to one another.

11. The method of claim 1, wherein the one or more process variables is monitored before the first resin and the component are combined to produce the first binder system.

12. The method of claim 1, wherein the one or more process variables is monitored when the first resin and the component are combined to produce the first binder system.

13. The method of claim 1, wherein the one or more process variables is monitored after the first resin and the component are combined to produce the first binder system.

14. The method of claim 1, wherein the one or more process variables comprises at least one of: a press speed, a temperature of the plurality of fibers, a size of the plurality of fibers, a shape of the plurality of fibers, a composition of the plurality fibers, an age of the plurality of fibers, ambient temperature, ambient humidity, ambient pressure, application rate of the binder system to the plurality of fibers, a fiberglass product cure speed, a fiberglass product cure temperature, a pressure applied to the fibers during production of the first fiberglass product, a density of the first fiberglass product, a thickness of the first fiberglass product, a formaldehyde emissions during production of the binder system, a formaldehyde emissions from the first fiberglass product, a tear strength of the first fiberglass product, a dry tensile strength of the first fiberglass product, a wet tensile strength of the first fiberglass product, a moisture resistance of the first fiberglass product, a dimensional stability of the first fiberglass product, an appearance of the first fiberglass product, a composition of the first resin, a composition of the component, or any combination thereof.

15. The method of claim 1, wherein the one or more monitored process variables comprises at least a first monitored process variable and a second monitored process variable, and wherein the first and second monitored process variables are monitored at the same time or at different times with respect to one another.

16. A method for preparing a binder system for use in producing fiber products, comprising:
combining a first resin and a component to produce a first binder system, wherein the component comprises a second resin, an additive, or a combination thereof, and wherein the first binder system has a first weight ratio of the first resin to the component, based on a solids weight of the first resin and the component;
contacting a first plurality of glass fibers with the first binder system to product a first mixture;
at least partially curing the first binder system in the first mixture to produce a first fiberglass product;
monitoring one or more process variables;
evaluating the one or more monitored process variables;
adjusting an amount of the first resin, the component, or both combined with one another to produce a second binder system having a second weight ratio of the first resin to the component, based on a solids weight of the first resin and the component, wherein the adjustment in the amount of the first resin, the component, or both is based, at least in part, on the evaluation of the one or more monitored process variables;
contacting a second plurality of glass fibers with the second binder system to produce a second mixture; and
at least partially curing the second binder system in the second mixture to produce a second fiberglass product.

17. The method of claim 16, wherein the additive is present and comprises a dispersant, a wax, a filler material, an extender, a surfactant, a release agent, a dye, a fire retardant, a formaldehyde scavenger, a biocide, a viscosity modifier, a pH adjuster, a coupling agent, a lubricant, a defoamer, or any combination thereof.

18. The method of claim 16, wherein the one or more monitored process variables comprises at least a first process variable and a second process variable, wherein the first process variable is monitored before the first resin and the component are combined to produce the first binder system, and wherein the second process variable is monitored after the first resin and the component are combined to produce the first binder system.

19. The method of claim 16, wherein the one or more monitored process variables comprises at least a first process variable and a second process variable, wherein the first process variable is monitored before the first resin and the component are combined to produce the first binder system, and wherein the second process variable is monitored after the first binder system is at least partially cured to produce the first fiberglass product.

20. A system for producing a binder system and one or more fiber products, comprising:
a first vessel in fluid communication with a first flow control device, wherein the first vessel is adapted to contain a first resin;
a second vessel in fluid communication with a second flow control device, wherein the second vessel is adapted to contain a component, wherein the component comprises a second resin, an additive, or a combination thereof;
a least one process variable monitor adapted to monitor one or more process variables;
a control system for evaluating the one or more monitored process variables and controlling the first flow control device, the second flow control device, or both based on the evaluated one or more monitored process variables;
a mixer adapted to combine the first resin and the component to produce a first binder system; and
a binder application unit configured to contact at least a portion of the first binder system with a plurality of fibers to produce a binder system and fiber mixture.
